(19) United States
(12) Patent Application Publication
(10) Pub. No.: US 2009/0007252 A1
(43) Pub. Date: Jan. 1, 2009

(54) System and Method for Implementing Proxy-Based Auto-Completion on a Network

(76) Inventors: Erik J. Burckart, Raleigh, NC (US); Ori Pomerantz, Austin, TX (US)

Correspondence Address: DILLON & YUDELL LLP, 8911 N. CAPITAL OF TEXAS HWY., SUITE 2110, AUSTIN, TX, 78759, US

(21) Appl. No.: 11/769,847

(22) Filed: Jun. 28, 2007

(51) Int. Cl. G06F 15/16; G06F 17/00

(52) U.S. Cl. 726/12; 715/226

(57) ABSTRACT

A system and method for implementing forward proxy based auto-completion on a network, wherein the network includes a data center, at least one forward proxy, and a collection of clients coupled to the at least one forward proxy. The data center marks at least one input field in an application as relevant for auto-completion. In response to detecting a first client accessing the at least one input field in the application to input at least one data entry, the forward proxy parses the at least one data entry entered into the at least one input field. The forward proxy ranks by frequency of entry the at least one data entry entered into the at least one input field. In response to detecting a second client accessing the at least one input field in the application to input at least one data entry, the forward proxy performs auto-completion on the at least one input field, wherein the auto-completion includes displaying a collection of past data entries in an order of the ranking to facilitate completion of the at least one input field.

### BACKGROUND OF THE INVENTION

1. Technical Field

The present invention relates in general to the field of data processing systems and in particular, the field of transferring data among data processing systems. Still more specifically, the present invention relates to the field of facilitating the transfer of data among data processing systems.

2. Description of the Related Art

A “web page” is a source of information stored on a computer system (e.g., a “web server”) coupled to the Internet and specifically, the World Wide Web. Those with skill in the art will appreciate that the information on a web page is usually express in a markup language, such as the hypertext markup language (HTML) or extensible hypertext markup language (XHTML), and may include navigation information to other web pages via hypertext links.

Web pages may be retrieved by a remote computer (e.g., a “client) from the web server via a network connection. Depending on security restrictions, access to a particular web page may be limited to certain clients on a private network, such as a corporate intranet, or to certain clients with particular access permissions.

Those with skill in the art will also appreciate that web pages may include static text stored with the web server's file system (e.g., static web pages), or the web server may dynamically construct the HTML for each web page as the web page is requested by a client. Some web pages enable users to input information via forms to send back to the web server for processing.

### SUMMARY OF THE INVENTION

The present invention includes a system and method for implementing forward proxy based auto-completion on a network, wherein the network includes a data center, at least one forward proxy, and a collection of clients coupled to the at least one forward proxy. The data center marks at least one input field in an application as relevant for auto-completion. In response to detecting a first client accessing the at least one input field in the application to input at least one data entry, the forward proxy parses the at least one data entry entered into the at least one input field. The forward proxy ranks by frequency of entry the at least one data entry entered into the at least one input field. In response to detecting a second client accessing the at least one input field in the application to input at least one data entry, the forward proxy performs auto-completion on the at least one input field, wherein the auto-completion includes displaying a collection of past data entries in an order of the ranking to facilitate completion of the at least one input field.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of the an illustrative embodiment when read in conjunction with the accompanying figures, wherein:

FIG. 1 is a block diagram illustrating an exemplary network in which an embodiment of the present invention may be implemented;

FIG. 2 is a block diagram depicting an exemplary data processing system in which an embodiment of the present invention may be implemented;

FIG. 3A is a block diagram illustrating exemplary contents of a system memory of a proxy server according to an embodiment of the present invention;

FIG. 3B is a block diagram depicting exemplary contents of a system memory of a client according to an embodiment of the present invention;

FIG. 4 is a pictorial representation of a browser depicting a collection of designated auto-completion fields according to an embodiment of the present invention; and

FIGS. 5A-5B are high-level logical flowchart diagrams illustrating an exemplary method for implementing forward proxy-based auto-completion on a network according to an embodiment of the present invention.

### DETAILED DESCRIPTION OF AN ILLUSTRATIVE EMBODIMENT

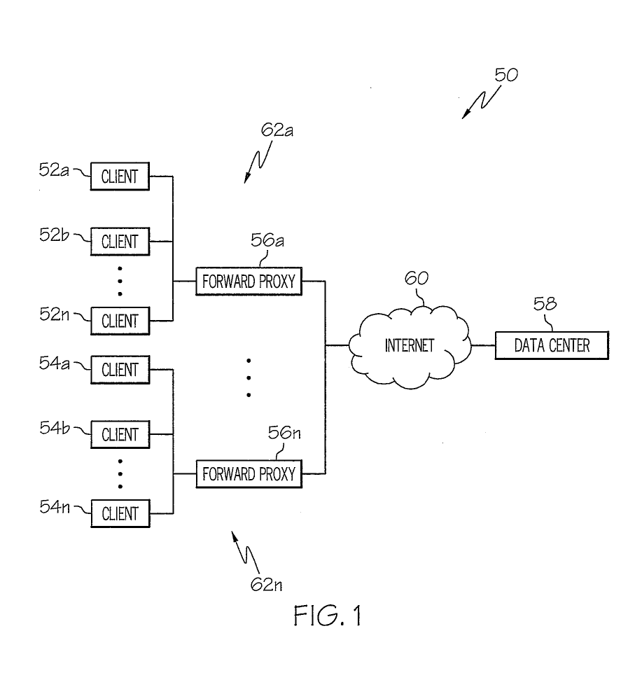

Referring now to the figures, and in particular, referring to FIG. 1, there is illustrated an exemplary network 50 in which an embodiment of the present invention may be implemented. As depicted, exemplary network 50 includes a collection of branches 62a-62n, which are coupled to data center 58 via Internet 60. Also, as shown, each branch includes a collection of clients coupled to a forward proxy. For example, branch 62a includes clients 52a-52n, which are coupled to forward proxy 56a. Branch 62n includes clients 54a-54n, which are coupled to forward proxy 56n. Those with skill in the art will appreciate that exemplary network 50 may include other components such as, but not limited to firewalls, routers, switches, and other network components that are not germane to the invention and are therefore not illustrated or discussed herein. Also, those with skill in the art will appreciate that the present invention is not limited to two branches or a single data center, but include any number of branches and data centers.

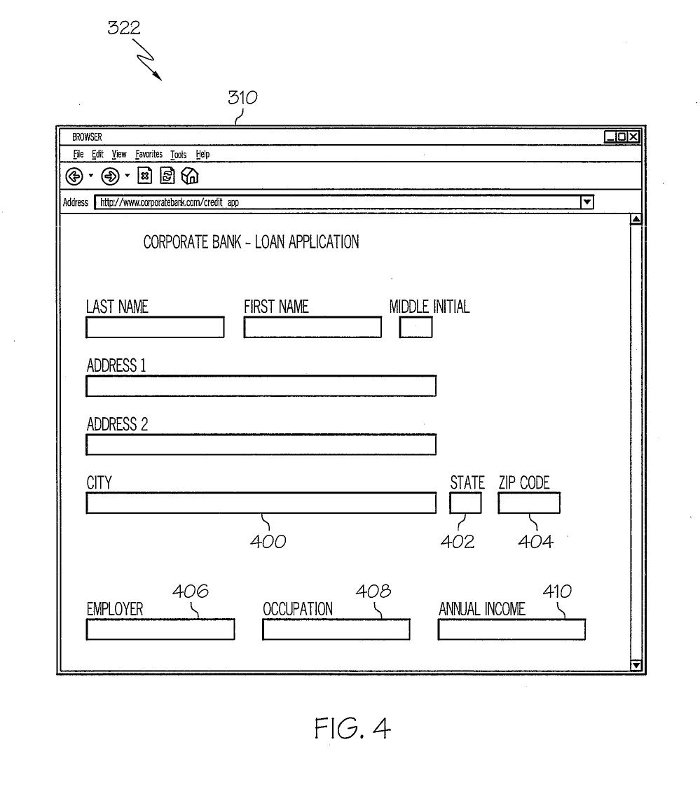

According to an embodiment of the present invention, branches 62a-62n send and receive data to data center 58 via Internet 60. A user may access a client (e.g., client 52a) within a branch (e.g., branch 62a) to request and/or send data to data center 58. Forward proxies 56a-56n are utilized to support Internet access for the coupled clients through a single server for security, caching, and/or filtering of information. Also, forward proxies 56a-56n support auto-completion of input fields specified by data center 58 according to an embodiment of the present invention, as discussed herein in more detail in conjunction with FIG. 4. Internet 60 may also be implemented as a local-area network (LAN), wide-area network (WAN) utilizing Ethernet, IEEE 802.11x, or any other communications protocol.

To facilitate discussion of the present invention, assume for exemplary purposes that each network 50 represents a network for a bank. Each branch (e.g., branches 62a-62n) represents a separate sub-network at each branch office of the bank. Data center 58 represents a main data center that acts as a central data repository for the bank network (e.g., network 50). Of course, those with skill in the art will appreciate that the present invention is not limited to the network configuration shown in FIG. 1, but also may be implemented by any type of network configuration.

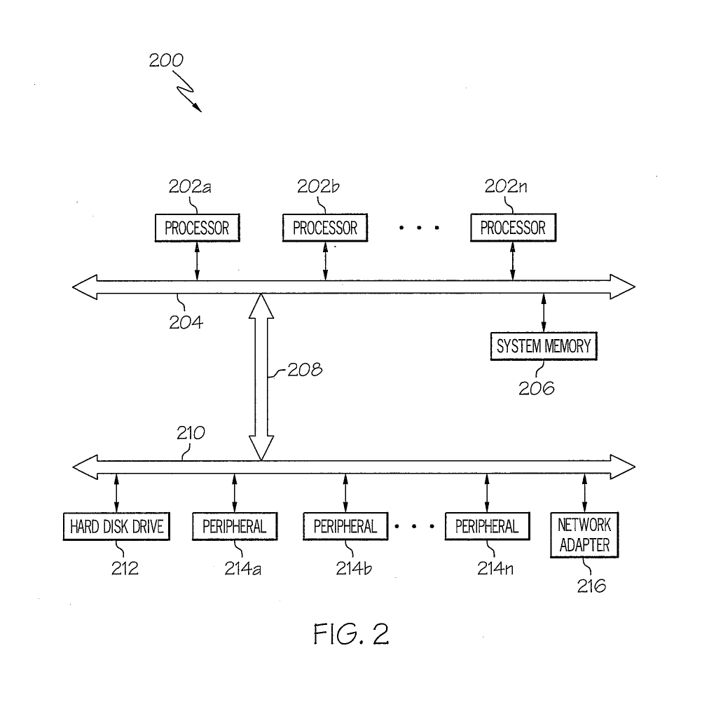

FIG. 2 is a block diagram depicting an exemplary data processing system 200, which may be utilized to implement clients 52a-52n, clients 54a-54n, forward proxies 56a-56n, and data center 58 as shown in FIG. 1. As illustrated, exemplary data processing system 200 includes a collection of processors 202a-202n that are coupled to a system memory 206 via a system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-214n, which may include, but are not limited to, optical drives, other hard disk drives, printers, input devices, and the like. Network adapter 216 enables data processing system 200 to communicate with other components of network 50, such as other clients 52a-52n, clients 54a-54n, forward proxies 56a-56n, Internet 60, and/or data center 58.

Those with skill in the art will appreciate that data processing system 200 can include many additional components not specifically illustrated in FIG. 2. Because such additional components are not necessary for an understanding of the present invention, they are not illustrated in FIG. 2 or discussed farther herein. It should be understood, however, that the enhancements to data processing system 200 provided by the present invention are applicable to data processing systems of any system architecture and are no way limited to the generalized multi-processor architecture illustrated in FIG. 2.

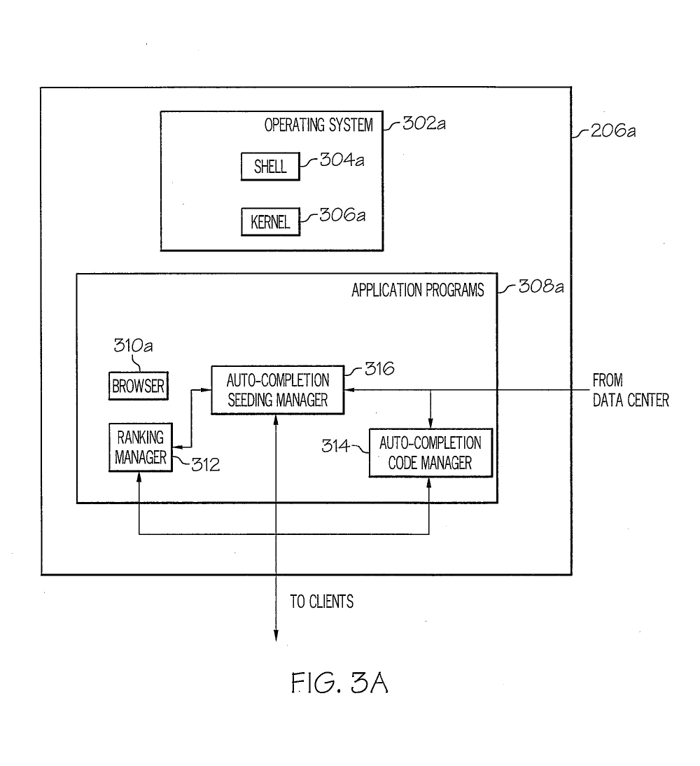

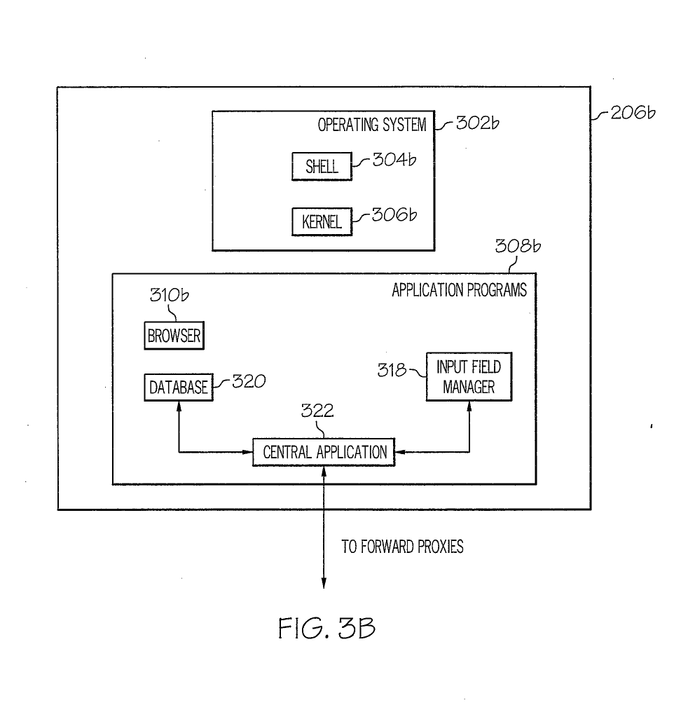

FIGS. 3A-3B are block diagrams illustrating exemplary contents of system memory 206a of forward proxies 56a-56n (FIG. 1) and exemplary contents of system memory 206b of data center 58 according to an embodiment of the present invention. As shown, system memory 206a-206b include operating system 302a-302b, which further include shells 304a-304b (as it is called in UNIX®), for providing transparent user access to resources such as application programs 308a-308b. Generally, shells 304a-304b, also called a command processor in Windows®, are generally the highest level of the operating system software hierarchy and serve as a command interpreter. Shells 304a-304b provide a system prompt, interprets commands entered by keyboard, mouse, or other input media, and sends the interpreted command(s) to the appropriate lower levels of the operating system (e.g., kernels 306a-306b) for processing. Note that while shells 304a-304b are a text-based, line-oriented user interface, the present invention will support other user interface modes, such as graphical, voice, gestural, etc. equally well.

As illustrated, operating systems 302a-302b also include kernels 306a-306b, which include lower levels of functionality for operating systems 202a-202b and application programs 308a-308b, including memory management, process and task management, disk management, and mouse and keyboard management. Application programs 308a-308b can include browsers 310a-310b utilized for access to Internet 60 (FIG. 1), word processors, spreadsheets, and other application programs.

In an embodiment of the present invention, users at each branch may access via clients 52a-52n or clients 54a-54n a central web site or another type of application (e.g., central application 322 of FIG. 3B) at data center 58. Central application 322 interfaces with database 320, and enables users from branches 62a-62n to access data stored in database 320. Input field manager 318 interfaces with central application 322 to designate input fields for auto-completion. Also, as depicted, central application 322 maintains a communications link with forward proxies 56a-65n via Internet 60.

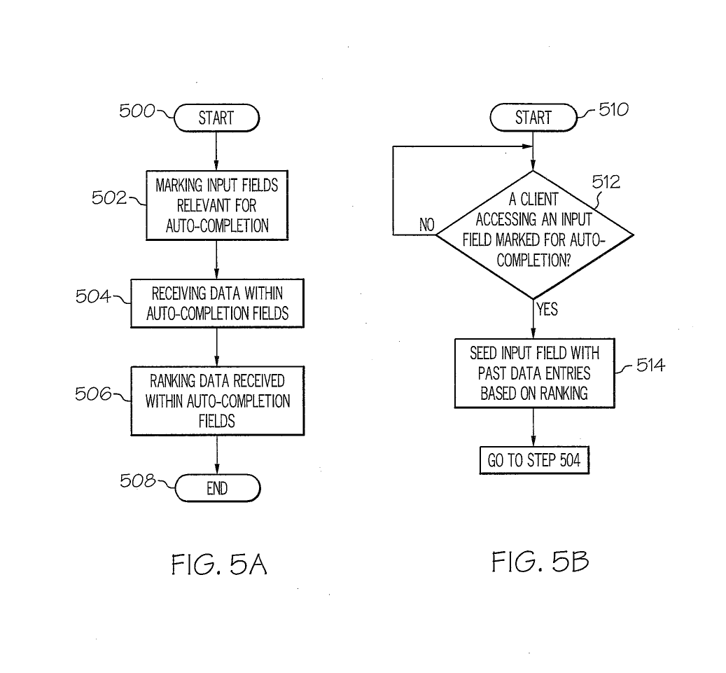

Referring now to FIG. 3A, system memory 206a of forward proxies 56a-56n include ranking manager 312, auto-completion code manager 314, and auto-completion seeding manager 316. As discussed herein in more detail in conjunction with FIGS. 4 and 5, ranking manager 312 examines and ranks the data received from clients 52a-52n and clients 54a-54n in input fields designated by input field manager 318 (FIG. 3B) for auto-completion. As users access central application 322 via clients 52a-52n or clients 54a-54n, their respective forward proxies 56a-56n will generate auto-completion code and seed auto-completion prompts (via auto-completion seeding manager 316 and auto-completion code manager 314) when the users begin entering data into input fields designated for auto-completion by input field manager 318 (FIG. 3B). The seeding of input fields designated for auto-completion will utilize past data entered into the input fields by other clients that access data center 58 via the same forward proxy. In other words, the past data utilized for seeding the input fields designated for auto-completion are proxy (or branch-specific), as previously discussed.

FIG. 4 is a graphical user interface (GUI) of central application 322 as displayed by a browser by clients 52a-52n or clients 54a-54n according to an embodiment of the present invention. According to an embodiment of the present invention, central application 322 is a program that enables users at branches 62a-62n to fill out a loan application online. Also, according to an embodiment of the present invention, access to central application 322 is enabled by utilizing browser 310 stored in system memory 206 of clients 52a-52n or clients 54a-54n. As depicted, central application 322 includes a collection of fields for a user to enter his or her name and address. Fields 400-410 are input fields designated by input field manager 318 (FIG. 3B) for auto-completion, herein after referred to as “auto-completion fields”.

FIGS. 5A-5B are high-level logical flowchart diagrams showing an exemplary method for implementing forward proxy based auto-completion on a network according to an embodiment of the present invention. Referring to FIG. 5A, the process begins at step 500, and proceeds to step 502, which illustrates input field manager 318 of data center 58 marking certain input fields in central application 322 as relevant for auto-completion.

As shown in FIG. 4, central application 322 is a loan application. Fields 400-410 are designated by input field manager 318 as input fields that are relevant for auto-completion. For example, in the abovementioned example of a bank with branch offices, certain types of data, such as location data (e.g., city, state and zip code fields 400-404) may be branch specific. If there is a large employer in the area of a branch office, employer field 406 and occupation field 408 may also be fields that would greatly benefit from auto-completion. When forward proxies 56a-56n receive data (shown in step 504) from clients 52a-52n or clients 54a-54n, ranking manager 312 ranks the data entered in the input fields designated for auto-completion, as illustrated in step 506. The process ends, as illustrated in step 508.

Referring now to FIG. 5B, there is illustrated a high-level logical flowchart depicting the auto-completion seeding process in accordance with an embodiment of the present invention. The process begins at step 510, which illustrates forward proxies 56a-56n determining if a client (e.g., clients 52a-52n or clients 54a-54n) are accessing central application 322 and have entered data into input fields marked for auto-completion. If the client is not accessing central application 322 and has not entered data into input fields marked for auto-completion, the process iterates at step 512. If the client is accessing central application 322 and has entered data into input fields marked for auto-completion, the process continues to step 514, which illustrates auto-completion seeding manager 316 and auto-completion code manager 316 seeding the input fields marked for auto-completion based on data entered from the specific branch as ranked by ranking manager 312. The process continues to step 504.

As discussed, the present invention includes a system and method for implementing forward proxy based auto-completion on a network, wherein the network includes a data center, at least one forward proxy, and a collection of clients coupled to the at least one forward proxy. The data center marks at least one input field in an application as relevant for auto-completion. In response to detecting a first client accessing the at least one input field in the application to input at least one data entry, the forward proxy parses the at least one data entry entered into the at least one input field. The forward proxy ranks by frequency of entry the at least one data entry entered into the at least one input field. In response to detecting a second client accessing the at least one input field in the application to input at least one data entry, the forward proxy performs auto-completion on the at least one input field, wherein the auto-completion includes displaying a collection of past data entries in an order of the ranking to facilitate completion of the at least one input field.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made herein without departing from the spirit and scope of the invention.

What is claimed is:

1. A computer-implementable method for implementing forward proxy based auto-completion on a network, wherein said network includes a data center, at least one forward proxy, and a plurality of clients coupled to said at least one forward proxy, said method comprising:
marking at least one input field in an application as relevant for auto-completion;
in response to detecting a first client accessing said at least one input field in said application to input at least one data entry, parsing said at least one data entry entered into said at least one input field;
in response to said parsing, ranking by frequency of entry, said at least one data entry entered into said at least one input field; and
in response to detecting a second client accessing said at least one input field in said application to input at least one data entry, performing auto-completion on said at least one input field, wherein said auto-completion includes displaying a plurality of past data entries in an order of said ranking to facilitate auto-completion of said at least one input field.

2. The computer-implementable method according to claim 1, wherein said performing auto-completion further comprises:
generating auto-completion code; and
seeding said at least one input field with said plurality of past data entries from said at least forward proxy.

3. The computer-implementable method according to claim 1, wherein said ranking further comprises:
collecting all entries entered into said at least one input field from said plurality of clients to said at least one forward proxy.

4. A data processing system for implementing forward proxy based auto-completion on a network, said data processing system comprising:
at least one processor;
a databus coupled to said at least one processor;
a computer-implementable medium coupled to said at least one processor via said databus, said computer-implementable medium storing computer-readable instructions executable by said at least one processor and configured for:
marking at least one input field in an application as relevant for auto-completion;
in response to detecting a first client accessing said at least one input field in said application to input at least one data entry, parsing said at least one data entry entered into said at least one input field;
in response to said parsing, ranking by frequency of entry, said at least one data entry entered into said at least one input field; and
in response to detecting a second client accessing said at least one input field in said application to input at least one data entry, performing auto-completion on said at least one input field, wherein said auto-completion includes displaying a plurality of past data entries in an order of said ranking to facilitate auto-completion of said at least one input field.

5. The data processing system according to claim 4, wherein said computer-readable instructions for performing auto-completion further comprises computer-readable instructions configured for:
generating auto-completion code; and
seeding said at least one input field with said plurality of past data entries from said at least forward proxy.

6. The data processing system according to claim 4, wherein said computer-readable instructions for performing said ranking further comprises computer-readable instructions configured for:
collecting all entries entered into said at least one input field from said plurality of clients to said at least one forward proxy.

7. A computer-usable medium embodying computer program code, said computer program code comprising computer-executable instructions configured for:
marking at least one input field in an application as relevant for auto-completion;
in response to detecting a first client accessing said at least one input field in said application to input at least one data entry, parsing said at least one data entry entered into said at least one input field;
in response to said parsing, ranking by frequency of entry, said at least one data entry entered into said at least one input field; and
in response to detecting a second client accessing said at least one input field in said application to input at least one data entry, performing auto-completion on said at least one input field, wherein said auto-completion includes displaying a plurality of past data entries in an order of said ranking to facilitate auto-completion of said at least one input field.

8. The computer-usable medium according to claim 7, wherein said instructions are further configured for:
generating auto-completion code; and
seeding said at least one input field with said plurality of past data entries from said at least forward proxy.

9. The computer-usable medium according to claim 7, wherein said instructions are further configured for:
collecting all entries entered into said at least one input field from said plurality of clients to said at least one forward proxy.
